(19) United States
(12) Patent Application Publication
(10) Pub. No.: US 2025/0229237 A1
(43) Pub. Date: Jul. 17, 2025

(54) GRAVITY-FED SPIRAL FLOW TREATMENT APPARATUS AND METHOD

(71) Applicant: Kannar Earth Science, Ltd., Lawrenceville, GA (US)

(72) Inventors: Samuel L. Cloete, Suwanee, GA (US); Paul Branch, Lawrenceville, GA (US)

(21) Appl. No.: 19/170,251

(22) Filed: Apr. 4, 2025

Related U.S. Application Data
(63) Continuation of application No. PCT/US23/76169, filed on Oct. 6, 2023.
(60) Provisional application No. 63/378,598, filed on Oct. 6, 2022.

(51) Int. Cl. B01F 25/83; B01F 25/721; B01F 35/71; B01F 101/09; G05D 7/06

(52) U.S. Cl. CPC B01F 25/83; B01F 25/721; B01F 35/714; B01F 35/71731; G05D 7/06; B01F 2101/09

(57) ABSTRACT

A gravity-fed treatment apparatus for the dispersion of an additive into a flow of granulated matter includes a vertical treatment chamber comprising a top inlet, a bottom outlet, and at least one wall disposed between the top and bottom defining an interior therebetween. The chamber further includes a feed port through the at least one wall and a plurality of vortex baffles, each extending angularly away from the wall into the interior at a respective angle. Each vortex baffle includes a flat portion and a flaring portion where the flaring portion curves away from a plane encompassing a surface of the flat portion. A portion of the flow of granulated matter spirals around an axis passing through the top and bottom of the chamber due to gravity and the shape of the vortex baffles.

### CROSS-REFERENCE TO RELATED APPLICATIONS

This application is a continuation of PCT Patent Application No. PCT/US2023/076169 entitled “GRAVITY-FED SPIRAL FLOW TREATMENT APPARATUS AND METHOD”, which was filed on Oct. 6, 2023, which claims benefit of and priority to U.S. Provisional Patent Application No. 63/378,598 entitled “SPIRAL FLOW TREATMENT APPARATUS”, which was filed on Oct. 6, 2022, the entire contents of all of which are hereby incorporated by reference in their entireties.

### TECHNICAL FIELD

The present disclosure relates to the field of gravity-fed granulated matter treatment apparatuses, and in particular to a treatment apparatus including baffles that are shaped and arranged to generate a spiral flow in the granulated matter, like seeds, whereby dispersion of treatment additives in the granulated matter is enhanced.

### BACKGROUND

Certain granulated agricultural products, such as seeds, grains, and fertilizers, are often treated with additives to protect them or produce desired qualities therein. For example, seed can be treated with biological agents and/or pesticides that protect the seeds from pests and disease. Indeed, protracted storage of grains and seeds can provide an ideal environment for growth of molds, some of which are toxic to people and animals, such as grain-fed swine, calves, rabbits, pheasants, chickens, turkeys and ducks. Likewise, it is common for fertilizer to be impregnated with additives to enhance desired qualities or produce desired results, such as enhanced flowability, shelf stability, or bioavailability.

However, treatment methods and additives can vary greatly. For example, additives can often be dry products designed to be mixed with granulated agricultural products or fluid solutions designed to coat granulated agricultural products. While there are a great number of apparatuses on the market to provide treatment of these products, they are often bulky, complex, invariable, and/or energy intensive. In fact, these characteristics are often necessary side effects of to ensure sufficient treatment. For example, certain “portable” treatment devices are often so large that they require a trailer for transport and require power to operate a mechanical mixing device. In contrast, another treatment method involves passing granulated agricultural products through a vertical treatment chamber into which both a flow of additive and granulated matters is passed and having baffles to deflect the matter and additive as it is pulled by gravity from top to bottom so that the additive and granulated matter mix. Although these vertical treatment chamber devices are desirable due to their reliance on gravity, lacking a mechanical mixing device and not requiring power to operate such, they often are bulky. Moreover, each of these vertical treatment chamber devices often focus only on a single type of granulated matter and additive.

Therefore, an unmet need remains for a treatment apparatus which incorporates design features allowing the apparatus to be smaller and more mobile, user-friendly, and more versatile in use while remaining efficient and effective in their treatment of a variety of granulated agricultural products with liquid or dry additives.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In view of the above, the present disclosure provides, in aspects, a gravity-fed treatment apparatus for granulated agricultural matter that is smaller, more mobile, user-friendly, and more versatile in use while remaining efficient in treatment due to its incorporation of various design features.

According to one or more embodiments, a gravity-fed treatment apparatus for the dispersion of an additive into a flow of granulated matter comprises a vertical treatment chamber having an inlet, at a top, and an outlet at a bottom, two U-shaped channel members having arms abutting one another so they define the periphery of an interior of the chamber between the top and bottom, a plurality of vortex baffles extending from the periphery into the interior of the chamber where each vortex baffle has a flat portion and a flaring portion curving up and away from a plane encompassing the first surface, and a first feed port disposed through one of the U-shaped channel members to deposit additive into the flow of granulated matter. In embodiments, some of the granulated matter flow from the inlet spirals around an axis passing through the top and bottom of the chamber as it is pulled by gravity towards the outlet due to the deflection of the baffles enhancing dispersion of the additive through the flow of granulated matter.

According to embodiments, the gravity-fed treatment apparatus further has a frustoconical-shaped hopper affixed to the inlet, through which granulated matter is passed.

In embodiments, the vortex baffles are serially disposed from opposed portions of the periphery, to enhance the spiral flow and, thereby, the dispersion of additive relative to the granulated matter.

In further embodiments, each of the vortex baffles are affixed to portions of the periphery so that the angle they are disposed at relative to the periphery is fixed. In other embodiments, one or more of the vortex baffles are pivotally affixed to the periphery so that the respective angle of the vortex baffle relative to the periphery is alterable. In certain embodiments, the pivotally affixed vortex baffle is operably connected to an adjustment bar configure to allow for infinite adjustment of the respective angle of the pivotally affixed vortex baffle. In embodiments, the adjustment bar is disposed on an opposed side of the periphery from the interior of the chamber. In other embodiments, the pivotally affixed vortex baffle contacts a protrusion from the periphery to secure the vortex baffle at a set respective angle. In additional embodiments, the location of the protrusion is adjustable relative to the periphery and the location is related to the set respective angle.

In more embodiments, one or more of the vortex baffles are removably affixed to the periphery. In certain embodiments, a portion of the removably affixed vortex baffle is disposed into and in frictional engagement with a slot into a portion of one of the U-shaped channel members.

In embodiments, the first feed port is in communication with a first metering device to control the input rate of additive to the interior of the chamber. In certain embodiments, the additive comprises a fluid, the first metering device comprises a chemical metering pump in fluid communication with the first feed port, and the first feed port comprises a nozzle configured to spray the additive into the interior of the chamber where it contacts the flow of granulated matter. In various embodiments, the additive is non-fluid and the first metering device is one of a fluted feed type, internal double run type, cup feed type, cell feed type, brush feed type, auger feed type, picker wheel type, and star wheel type. In further embodiments, the chamber further comprises a second feed port disposed through one of the U-shaped channel members and a second metering device in communication with the second feed port, wherein the second metering device is configured to control the input rate of additive to the interior of the chamber. In certain embodiments, the first metering device and second metering device are operably linked through a calibration unit configured to control the input rate of additive to the interior through each of the first feed port and second feed port.

In additional embodiments, the flow through the inlet is through a first metering device configured to control the flow rate of granulated matter into the interior of the chamber. In certain embodiments, the apparatus further comprises a second metering device in communication with the first feed port, wherein the first metering device and second metering device are operably linked through a calibration unit configured to maintain a preset ratio of the additive to granulated material in the flow.

According to one or more embodiments, a gravity-fed treatment apparatus for the dispersion of an additive into a flow of granulated matter comprises a vertical treatment chamber having an inlet, at a top, and an outlet at a bottom, at least one wall defining the periphery of an interior of the chamber between the top and bottom, a plurality of vortex baffles extending from the periphery into the interior of the chamber where each vortex baffle has a flat portion and a flaring portion curving up and away from a plane encompassing the first surface, and a first feed port disposed through one of the U-shaped channel members to deposit additive into the flow of granulated matter. In embodiments, some of the granulated matter flow from the inlet spirals around an axis passing through the top and bottom of the chamber as it is pulled by gravity towards the outlet due to the deflection of the baffles enhancing dispersion of the additive through the flow of granulated matter.

In some aspects of the present disclosure, a method is provided for treating granulated matter with an additive, the method including transporting the granulated matter to an inlet of a chamber, introducing the granulated matter from the inlet into the chamber, establishing a spiral flow of granulated matter in the chamber by providing a plurality of vortex baffles extending angularly away from portions of at least one wall of the chamber for deflecting and influencing the granulated matter flowing through the chamber, introducing the additive into an upper portion of the chamber, contacting the granulated matter with additive during the spiral flow as granulated matter moves towards an outlet of the chamber so the granulated matter becomes treated, and receiving treated granulated matter from an outlet of the chamber. In one instance, each of the plurality of vortex baffles in the method have a flat plate portion with a first surface and a flaring portion curving up and away from a plane encompassing the first surface.

In certain instances, the additive of the method is a dry compound and introducing the additive into the upper portion of the chamber involves introducing the additive from the inlet into the chamber. In another instance, the additive of the method is a dry compound and introducing the additive into the upper portion of the chamber involves introducing the additive from a port in an upper portion of the chamber.

In other instances, the additive of the method is a fluid solution and introducing the additive into the upper portion of the chamber involves introducing the additive from a nozzle disposed in an upper portion of the chamber. In at least one instance, the additive is introduced at a rate that is controlled by a chemical metering pump.

In certain aspects, the vortex baffles are removably attached to portions of the one or more walls of the chamber.

In further aspects, the method includes the step of adjusting the angle at which some or all of the vortex baffles extend away from the one or more walls of the chamber to accommodate optimum angles for certain granulated matter. In particular aspects, the rate that at least one of the granulated matter and additive is introduced in the method is controlled by a metering device.

In at least one aspect, the rate that both the granulated matter and additive is introduced is calibrated through operative control of the metering device.

### BRIEF DESCRIPTION OF THE DRAWINGS

The foregoing, as well as the following Detailed Description, is better understood when read in conjunction with the appended drawings. For the purposes of illustration, there is shown in the drawings exemplary embodiments; however, the presently disclosed subject matter is not limited to the specific methods and instrumentalities disclosed.

The embodiments illustrated, described, and discussed herein are illustrative of the present invention. As these embodiments of the present invention are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1 illustrates a top perspective view of a vortex baffle utilized in the chamber of a treatment apparatus according to one embodiment where the vortex baffle has a flat portion and flaring portion curving up and away from the flat portion such that one corner curves up and away;

FIG. 2 illustrates a top perspective view of a vortex baffle utilized in the chamber of a treatment apparatus according to one embodiment where the vortex baffle has a flat portion and flaring portion curving up and away from the flat portion, such that a different corner than that of FIG. 1 curves up and away;

FIG. 3 illustrates an elevation view of a treatment apparatus according to one or more embodiments having a vertical chamber with a portion cut away to show the vortex baffles (similar to those of FIG. 1 and FIG. 2), nozzle feed port, and granulated matter, metering devices to control the flow rate of granulated matter and additive into the chamber, an adjustment bar to control the respective angle of the vortex baffles, and a conveyor with a portion cut away to show the transport of granulated matter exiting the vertical chamber away therefrom;

FIG. 4 illustrates a top view of a pile of seed, on the left, after being passed through a treatment apparatus according to prior construction and a pile of seed, on the right, after being passed through a treatment apparatus according to one or more embodiments wherein the pile of seed on the right demonstrates a more thorough coating by an additive;

FIG. 5 illustrates an elevation view of a vertical chamber of a treatment apparatus with a cut away to show an interior according to one or more embodiments having vortex baffles and both a fluid and dry feed port, wherein a portion of the flow of granulated matter deposited through the inlet spirals around an axis passing through the top and bottom of the chamber as it is pulled by gravity towards an outlet due to the deflection of the granulated matter by the plurality of vortex baffles to enhance dispersion of the additive relative to the granulated matter;

FIG. 6 illustrates an elevation view of two vertical chambers according to one or more embodiments nested together having feed ports to input additives at flow rates controlled by metering devices such that dispersion of the additives into the flow of granulated matter is enhanced;

FIG. 7 illustrates a perspective view of a portion of the vertical chamber of a treatment apparatus according to one or more embodiments where the chamber is formed of two U-shaped channel members which can be affixed together and vortex baffles that are removably attached into a slot formed in the U-shaped channel member to hold the baffle at a set angle as demonstrated by the removed baffle shown in dashed lines; and

FIG. 8 illustrates a perspective view of a portion of the vertical chamber of a treatment apparatus according to one or more embodiments where the chamber is formed of two U-shaped channel members which are pivotally connected and vortex baffles that are pivotally attached inside each U-shaped channel member and held at a set angle by a moveable protrusion.

### DETAILED DESCRIPTION

The following description and figures are illustrative and are not to be construed as limiting. Numerous specific details are described to provide a thorough understanding of the disclosure. In certain instances, however, well-known or conventional details are not described in order to avoid obscuring the description. Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way.

Alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure.

### Device Generally

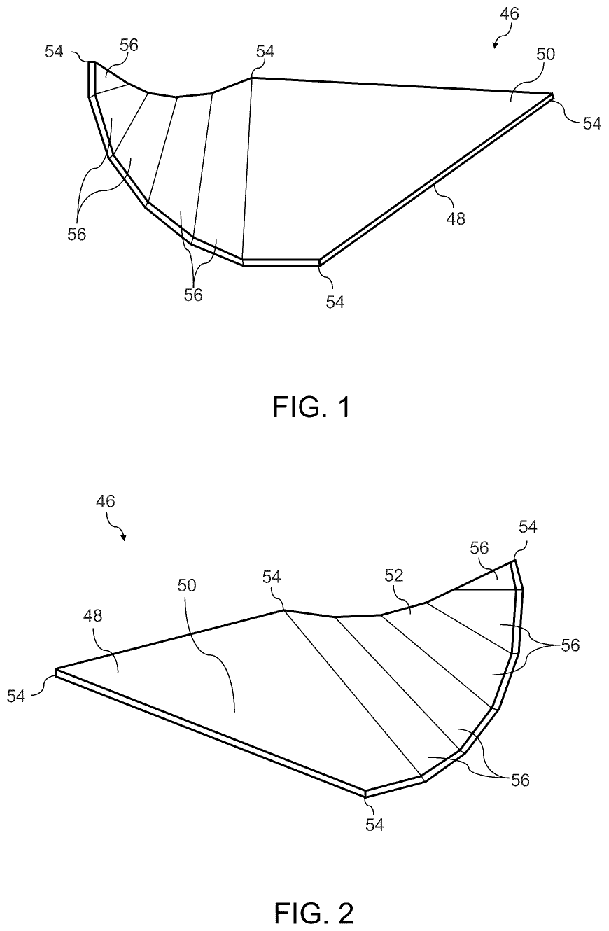

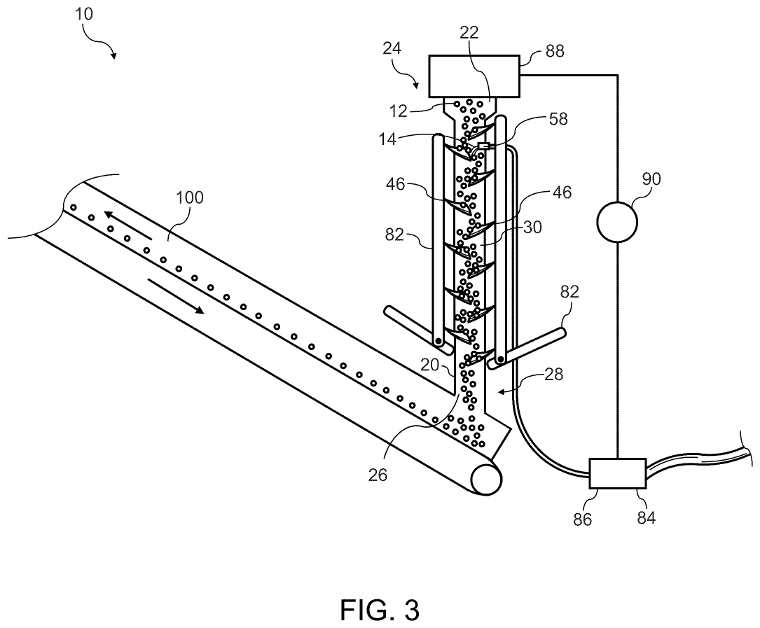

In general, the apparatus 10 comprises a vertical chamber 20, as in FIG. 3, having vortex baffles 46, such as those in FIGS. 1-2, arranged and angularly disposed therein as to enhance mixing of an additive 14 (liquid or dry) input through a feed port 58 and granulated matter 12 as granulated matter 12 is passed from an inlet 22 at a top 24 thereof to an outlet 26 at a bottom 28. In embodiments, mixing of the additive 14 and granulated matter 12 is enhanced due to a spiral flow generated around a vertical central axis 62 of the chamber 20 as granulated matter 12 is passed from the inlet 22 to the outlet 26. In further embodiments, the deflection of the granulated matter 12 as it passes through the chamber 20 by the vortex baffles 46 causes increased dispersion of an additive 14 therein. In particular, the shape and arrangement of vortex baffles 46 in the chamber causes increased dispersion due to one or more of gravity, the spiral flow of the granulated matter 12, and the motion and increased interaction of individual granules in the flow as a result of the deflection. For example, as granules of the granulated matter 12 are deflected by a vortex baffle 46, the shape and angular arrangement of the vortex baffle 46 causes a rolling motion of the granules, increasing the surface area thereof interacting with the additive 14 and the dispersion of the additive 14 through the granulated matter 12. Herein, the term mixing is meant to represent both dispersion and coating of granulated matter 12 by the additive 14. In the instance of coating, such as when the additive 14 is liquid, the apparatus 10 produces more uniform and complete coverage of the granulated matter.

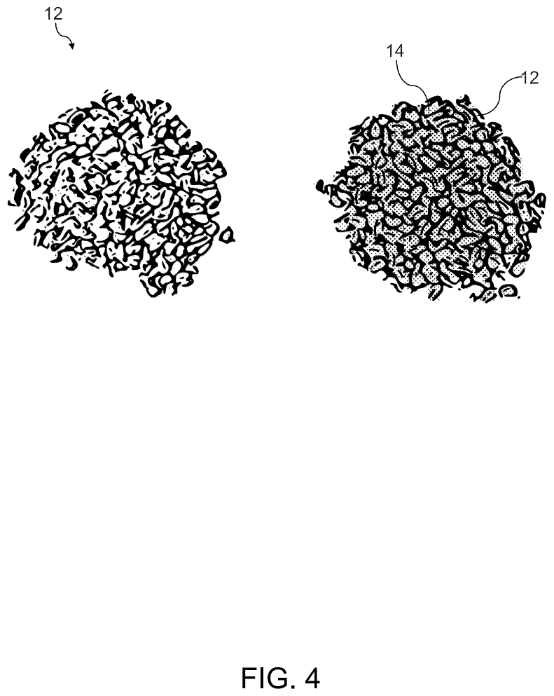

The ability of the apparatus 10 to provide enhanced mixing, as compared with treatment devices having flat baffles, allows for a more energy efficient device (due to the use of gravity as part of the treatment process), which can be smaller, particularly in vertical height, and have fewer baffles. For example, an gravity fed apparatus design not producing a spiral flow based on the design and layout of flat baffles therein commonly needs to be up to 10.5 feet tall to provide sufficient treatment of granulated matter. However, an apparatus 10 according to the present embodiments having vortex baffles 46 disposed in the chamber 20 produces a spiral flow and only needs to be approximately 4 feet tall to produce a similar level of treatment. Indeed, in FIG. 4, the pile of granulated matter 12 on the left represents corn that was treated through an apparatus having flat baffles in a chamber having a 4 foot vertical height and the pile of granulated matter 12 on the right represents corn that was treated with an apparatus 10, according to the present embodiments, having vortex baffles 46 arranged in a chamber 20 that has a four foot vertical height. Comparison of the piles in FIG. 4 demonstrates a more uniform and efficient mixing of additive 14 therethrough is provided by an apparatus 10 according to the present embodiments. Accordingly, the apparatus 10 is more efficient, user friendly, transportable, and useable than designs not producing a spiral flow. However, it is also foreseen that the size of the apparatus 10 of the present embodiments producing a spiral flow may be any size to accommodate varied types of granulated matter 12 and additives 14, allowing the apparatus 10 to be more usable.

### Elements

While various features and elements have been described in reference to particular embodiments and variations above, it is to be understood that no limitation of the scope of this disclosure is hereby intended. Thereby, elements and features might be utilized in any combination and for any embodiment to which it is particularly useful. To further promote understanding of the principles of the present disclosure, additional discussion related to particular elements of the present discussion is provided below.

### Chamber

In embodiments, the vertical chamber 20 comprises one or more walls 30 which form the periphery for the interior 44 of the chamber 20. In embodiments, the number of walls 30 may facilitate a particular shape for chamber 20. For example, a cylindrical shape chamber 20 having a single circular wall 30, a triangular prism shaped chamber 20 having three walls 30, and a rectangular prism shaped chamber 20 having four walls, as in FIGS. 3 and 5-6. The shape of the chamber 20, generally facilitated by the number and arrangement of walls 30, affects the shape of vortex baffles 46 mounted therein, in embodiments. Indeed, a cylindrical shaped chamber 20 could require vortex baffles 46 have a rounded portion to contact and be affixed with the periphery of the interior 44 thereof.

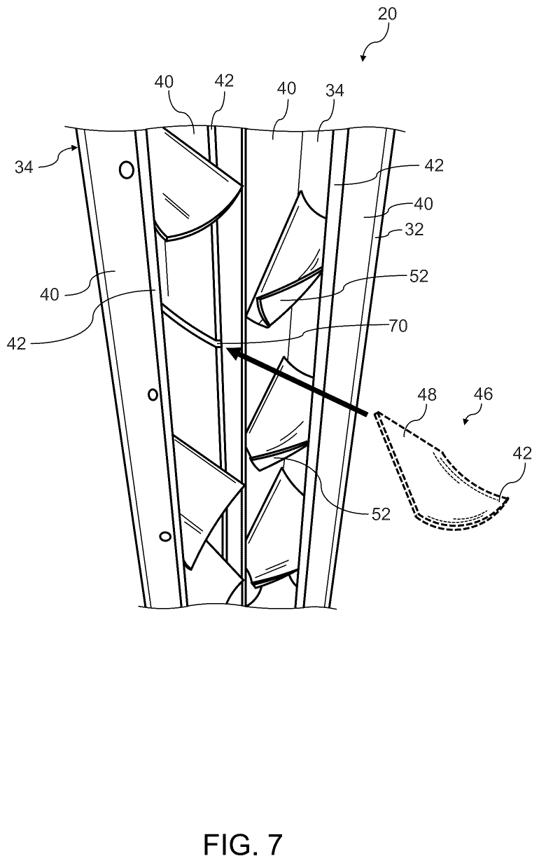

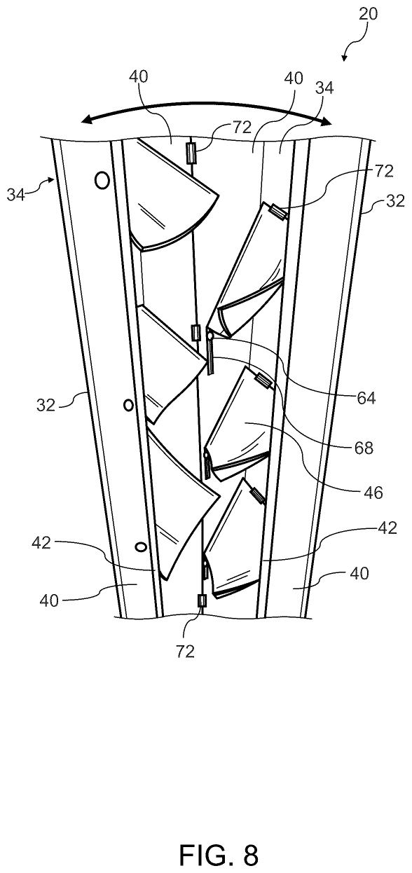

In at least one embodiment, the vertical chamber 20 comprises two U-shaped channel members 32 having edges 42 that abut together to facilitate the formation of the walls 30 of the chamber 20 and define the interior 44 thereof as in FIGS. 7 and 8. In embodiments, the U-shaped channel members 32 each have a central segment 34 having arm segments 40 extending away therefrom and terminating in an edge 42 which abuts the edge 42 of another U-shaped channel member 32 when forming the chamber 20. Accordingly, each of the central segment 34 and arm segments 40 form all or a portion of the walls 30 of the chamber 20, in embodiments. In at least one embodiment, the vertical chamber 20 comprises a single U-shaped channel member 32 and a wall 30 which has portions thereof which abut the edges 42 of the arm segments 40 of the U-shaped channel member 32 to form the interior 44 of the chamber 20.

U-shaped channel members 32 provide several benefits including easy access to the interior 44 facing portions of the chamber 20, such as vortex baffles 46, and the convenient grouping of elements of the apparatus 10 to allow for simple assembly and maintenance. Such benefits are particularly apparent in embodiments where the U-shaped channel members 32 have portions removably affixed together as in FIGS. 7 and 8. Indeed, FIG. 7 provides an embodiment wherein each of the U-shaped channel members 32 are removably affixed together about both edges 42 of each of their arm segments 40. In contrast, FIG. 8 provides an embodiment wherein the U-shaped channel members 32 are removably affixed together about one edge 42 of each of their arm segments 40, and pivotally attached, by a hinge 72, about the other edge 42 of each of their arm segments 40. Thereby, in the embodiment of FIG. 8, each of the U-shaped channel members 32 can swing open relative of the other to expose the interior facing portions of the chamber 20.

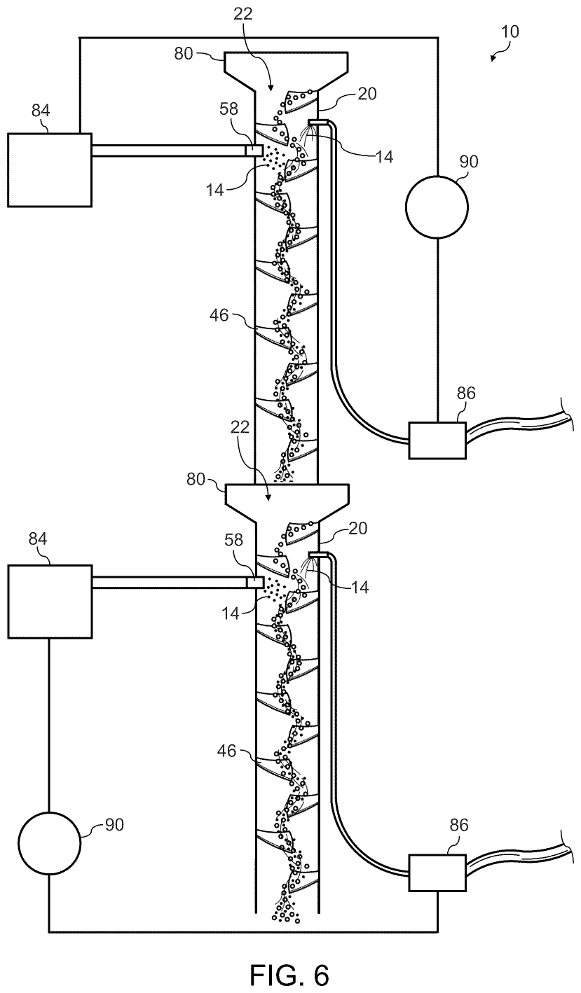

In another embodiment, a plurality of chambers 20 can be affixed together as in FIG. 6 so that input into one or more chamber 20 is provided through the outlet 26 of another chamber. As in FIG. 6, the chambers 20 can be nested together, thereby providing the ability to accommodate a number of separate additive 14 treatments with an apparatus 10. FIG. 3 shows a pile of granulated matter 12, specifically corn, on the left, that has been subjected to treatment with a liquid additive 14 in a specific chamber having flat baffles, i.e., baffles without a flaring portion 52. Alternatively, FIG. 3 also shows a pile of the same granulated matter 12 on the right that has been subjected to a nearly identical treatment with the same liquid additive 14 in the specific chamber having vortex baffles 46, including the flaring portion 52, instead of flat baffles. As shown in FIG. 3, the pile of granulated matter 12 on the right has a more complete coating with the additive 14 demonstrating a better mixing process, due to factors discussed previously, within the same length of vertical chamber 20. As a result of the use of the vortex baffles 46 within the chamber 20 and the enhanced mixing, the length of a vertical chamber 20 can be reduced, allowing each chamber 20 to be somewhat modular to an apparatus 10.

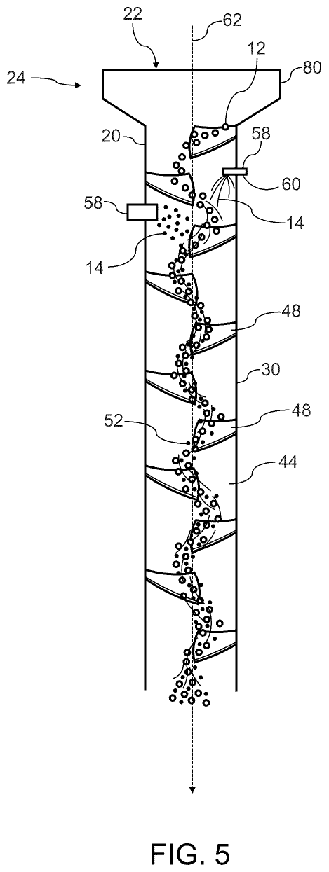

In embodiments, the inlet 22 at the top 24 and outlet 26 at the bottom 28 might be the size of the entire respective top 24 or bottom 28, making the chamber 20 open on either respective end. In other embodiments, the inlet 22 and outlet 26 may be a smaller size, such as that of a portion of the top 24 or bottom 28, making the chamber 20 relatively more closed. The embodiments of FIGS. 3 and 5 have an open top 24 and bottom 28 which allows for a consistent spiral flow, as granulated matter 12 is added during treatment. Indeed, use of an open bottom prevents clogging and bridging of granulated matter. However, it is foreseen that certain embodiments might utilize a smaller outlet 26 at the bottom 28 to allow for additional mixing and/or coating before the treated granulated matter 12 exits the chamber 20. Moreover, in embodiments, the top or bottom can include a mechanism, such as a shutter or slide, to selectively open or close the inlet 22 or outlet 26, fully or partially, during treatment.

### Vortex Baffles

In embodiments, the apparatus 10 includes vortex baffles 36 affixed to the chamber 20 about the periphery of and extending angularly into the interior 44. In embodiments, each of the vortex baffles 46 has a shape that is different from a flat baffle. Indeed, in embodiments, each vortex baffle 46 includes a flat portion 48 and flaring portion 52. The flaring portion 52, in such embodiments, curves up and away from a plane passing through a surface 50 of the flat portion 48 as shown in FIGS. 1 and 2. Indeed, in the embodiments of FIGS. 1 and 2, the vortex baffle 46 includes four corners 54, where a plane passes through three of the corners 54 and one of the corners 54 is disposed above that plane. As shown in FIGS. 1 and 2, the curvature of the flaring portion 52 may be achieved through a number of stages 56 which, each disposed at a different angle relative to a plane passing through a surface 40 of the flat portion 48 in embodiments. However, as shown in FIGS. 7 and 8, the curvature may be smooth in other embodiments.

In embodiments, each vortex baffle 46 may be shaped and arranged within the chamber 20 to provide for a particular direction of the spiral flow. For example, the shape of each of the vortex baffles 46 in FIGS. 1 and 2 have flaring portions 52 coinciding with different corners 54. Thereby, granulated matter 12 and additive 14 may form a clockwise or counterclockwise spiral flow around the central axis 62. In embodiments, the location of the apparatus 10 may influence a desired direction of spiral flow and, also, the shape and arrangement of vortex baffles 46 within the chamber 20.

While significant description has been provided herein regarding certain embodiments of the vortex baffle 46, it is also foreseen that other shapes might further be utilized. Indeed, the previously disclosed vortex baffle 46 may be only one shape capable of producing the desired spiral flow, rotation, and mixing under the influence of gravity. For example, one embodiment of a vortex baffle 46 could have a portion demonstrating a sinuous curve and a particular slope which, during deflection of granulated matter 12 and additive 14 generates similar desired motion and enhanced mixing. Accordingly, the term vortex baffle 46 utilized herein encompasses a baffle that is not flat and that due to its shape and its disposition within the chamber, produces the above-mentioned desired motion and enhanced mixing.

In embodiments, the vortex baffles 46 are affixed to the interior surface of the walls 30 or U-shaped channel members 32 making up the chamber 20 and extend angularly therefrom. In embodiments, the angle at which the vortex baffle extends 46 into the interior 44 is a factor which directly influences the mixing efficiency by affecting the spiral flow and motion of the granules in a flow of granulated matter 12 with the additive 14. The angle is not alterable in certain embodiments, such as in FIGS. 5 and 6, where the baffle is fixed to the interior side of the wall 30. However, in other embodiments, the angle is alterable.

Indeed, in one embodiment the angle is alterable through the removal and replacement of removably attached vortex baffles with others which facilitate a different angle, such as in FIG. 7. As shown in FIG. 7, a vortex baffle 46 may be disposed in and held stationary by a slot 70 into a wall 30 or portion of a U-shaped channel 32. Removably attached vortex baffles 46 allow for removal and replacement with a similar or different vortex baffle 46 in embodiments. One of the differences between vortex baffles 46 may be their shape at points where they engage the slot 70, allowing for variations in angles between different vortex baffles 46 in embodiments. Alternatively, removable vortex baffles 46 can allow for use of those having varied shapes to customize the ability of the apparatus 10 to administer a treatment of additive 14 to granulated matter 12. In embodiments, slots 70 may be formed into a protruding member from the interior surface of the wall 30, into the wall 30 partially, or fully through a wall 30. In embodiments, the slot 70 can also have various features which provide enhanced frictional engagement, i.e., grip, of a vortex baffle 46, to prevent its removal. For example, the slot 70 could contain a rubber gasket or similar feature to enhance the security of the vortex baffle 46 in the slot. In yet further embodiments, the slot 70 can also have a lock or locking mechanism to hold a vortex baffle 46 in the slot 70.

In other embodiments, the angle is adjustable and user selectable through other means, such as that shown in FIGS. 3 and 8. Indeed, as shown in FIG. 3, the vortex baffles 46 may be affixed to a wall 30 by being disposed into and through an aperture through the wall 30. In embodiments, the portion of the vortex baffle 46 extending outside the chamber 20 may be manipulated to adjust the angle of the vortex baffle 46 within the interior 44. Each vortex baffle 46 can be adjusted individually, in certain embodiments, or in concert with others in other embodiments, such as through a pivotally connected user manipulable adjustment bar 82, shown in FIG. 3. In embodiments, the aperture can include various features which provide a seal to the interior 44 of the chamber 20 around the vortex baffle 46 disposed therein and which aid in rending a vortex baffle 46 disposed therein stationary. For example, the aperture could be lined about a periphery with a rubber gasket or similar feature to enhance the security of the vortex baffle 46 therein. In yet further embodiments, the aperture can also have a lock or locking mechanism to hold a vortex baffle 46 inserted therein, in addition to or as a replacement to the adjustment bar 82. Likewise, the adjustment bar 82 can also include a similar lock or locking mechanism, in embodiments.

As shown in FIG. 8, the vortex baffles 46 may be pivotally affixed to a wall 30 or U-shaped channel member 32, such as through a hinge 72. In embodiments, the hinge 72 pivotally attaching the vortex baffle 46 allows the angle thereof to be alterable. In still further embodiments, the angle may be selectable through engagement of a portion of the vortex baffle 46 with an individually locatable protrusion 64 extending from the wall 30 or U-shaped channel member 32 into the interior 44 as in FIG. 8. Moreover, the protrusion 64 bay be selectively locatable by movement along a channel 68 or track disposed on or into a portion of the wall 30 or U-shaped channel member 32. Accordingly, in at least one embodiment, the vortex baffle 46 may be pivoted up or down and held at that angle by the protrusion 64 which is moved to its desired location by movement along a channel 68 or track. In embodiments, that protrusion 64 or channel 68 can include a lock or locking mechanism to hold the protrusion 64 stationary relative to the channel 68.

In embodiments, the vortex baffles 46 are affixed to the interior surface of opposed walls 30 or U-shaped channel members 32 making up the chamber 20. In embodiments, the vortex baffles 46 are arranged serially along opposed walls 30, or portions of walls 30 or U-shaped channel members 32 as in FIGS. 3, 5, and 6. That is, following the central axis 62 from the top 24 to the bottom 28, no vortex baffles 46 are disposed directly across the central axis 62 from another vortex baffle 46, i.e., each vortex baffle 46 is disposed in staggered relation to another across the central axis 62. The arrangement of the vortex baffles 46 within the interior 44 is a factor which also directly influences the mixing efficiency by affecting the spiral flow and motion of the granules in a flow of granulated matter 12 with the additive 14. However, it is foreseen that vortex baffles 46, in embodiments, may be arranged on both adjacent walls 30 or portions of the wall 30 or U-shaped channel members 32 in embodiments, if such arrangement produces a spiral flow, along with the shape of the vortex baffle 46 itself.

### Feed Port

In embodiments, the apparatus 10 has one or more feed ports 58, as shown in FIGS. 3, 5, and 6, which administer additive 14 into the interior 44 of the chamber 20. In certain embodiments, the feed port 58 is a spray nozzle 60 configured to input a fluid additive 14 into a flow of granulated matter 12, to coat the surface area thereof. In alternative embodiments, the feed port 58 may be configured to input a dry additive 14 into the flow of granulated matter 12, to disperse and mix the additive 14 evenly throughout. In certain embodiments, the apparatus 10 might have multiple feed ports 58, such as one for dry additive 14 and a spray nozzle 60 for liquid additive 14, thereby allowing treatment with multiple additives 14. In certain embodiments, the feed port 58 is located at or near a top 24 of the chamber 20. However, in other embodiments, the feed port 58 may be disposed at some other point along the chamber 20. Further, in at least one embodiment, the apparatus 10 does not have a feed port 58, instead relying on the additive 14 to be input into the chamber 20 through the inlet 22.

### Metering Device

In embodiments, the apparatus 10 includes a metering device 84 for a liquid additive 14, as shown in FIGS. 3 and 6, such as a chemical metering pump 86. In other embodiments, the apparatus 10 includes a metering device 84 for dry additive 14, as shown in FIG. 6. Through the metering device 84, the input rate of the additive 14 is controlled. In certain embodiments, multiple metering devices 84 are provided, such as one for each liquid and dry additive 14. However, in embodiments, both metering devices 84 may be for liquid or dry additives 14. In other embodiments, the apparatus 10 may have a metering device 88 for granulated matter 12. Thereby, the flow rate of granulated matter 12 may be controlled. In embodiments involving either granulated matter 12 or dry additive, the metering device may be one or more of a fluted feed type, internal double run type, cup feed type, cell feed type, brush feed type, auger feed type, picker wheel type, and star wheel type.

In further embodiments, the metering device 84, 88 may be selectively adjustable to control the rate of material being moved through the inlet 22 or feed port 58. Here, the rate is understood as the amount of material moved through the metering device 84, 88 per unit of time or per operative motion of the metering device 84, 88. For example, in an embodiment, a fluted feed roller metering device 84 may be adjustable to change the amount of material moved therethrough. Moreover, it is also foreseen that the metering device 84, 88 may have additional adjustable internal portions which limit the flow of material to control the standard rate of material therethrough.

In certain embodiments, multiple metering devices 84, 88 can be controlled through a calibration unit 90 in operative communication with each as in FIGS. 3 and 6. Through the calibration unit 90, the rate of additive 14 can be controlled and/or a ratio of one additive 14 to another or additive 14 to granulated matter 12 can be set and maintained.

### Hopper

In embodiments, the apparatus 10 can include a hopper 80 affixed to the top 24 of a chamber 20 so that granulated matter 12 passing into the inlet 22 must first pass through the hopper 80, as in FIGS. 3, 5, and 6. In embodiments, the hopper 80 provides storage for a volume of granulated matter 12 intended to be treated. Alternative, the hopper 80 allows for the collection of granulated matter 12 in instances where the more than the inlet 22 can accept is delivered at in too short a time period. In various embodiments, the hopper 80 may be any shape, size, or capacity which allows for the storage of a volume of granulated matter and the attachment/integration of the top 24 of the chamber. However, in a specific embodiment, the hopper 80 may be frustoconical shaped, as in FIGS. 3, 5, and 6. Indeed, in various embodiments, it is foreseen that the hopper 80 may be removably affixed to the chamber 20 and/or a granulated matter metering device 88 so that it can be replaced. In embodiments, the hopper 12, however, will generally be a hollow enclosure having an aperture to allow granulated matter 12 to be deposited therein and another aperture 14 through which material can be deposited into an opening 20 of the metering device 16.

In embodiments, a hopper 80 may be constructed of materials such as metal, plastic, rubber, or other useful material. Indeed, in an embodiment, a hopper 80 might even be constructed of or with wood. In certain embodiments, the hopper 80 may have a selectively engageable cap or lid for one or more of its apertures to enclose or protect the chamber 20 when not in use. For example, a lid on an opening of the hopper 80 can prevent water or other material from entering the hopper 80 and/or to secure and make the apparatus 10 safer when not in use. In embodiments, an opening of the hopper 80 might be blocked by a cover, such as a flexible tarp or rigid panel.

In certain embodiments, the hopper 80 may have one or more sensors to determine conditions within the hopper 80, such as the level of material in the hopper 80 or the humidity level inside the hopper 80. In at least one embodiment, the hopper 80 has a level sensor to indicate the presence of granulated matter 12 up to a certain level in the hopper 80. The level sensor may be of a contact or non-contact variety. Information from one or more sensors can be utilized by a calibration unit in various embodiments to control a metering device 88, such as that for the granulated matter. In certain embodiments, the hopper 80 may include a light which is selectively operated based on information received from a sensor. For example, the hopper 80 may include a light which turns on when the hopper 80 is full, to provide an indication to a user of the device.

### Conveyor

In embodiments, the apparatus 10 includes a conveyor 100, as in FIG. 3, to move matter. For example, in FIG. 3, the conveyor 100 takes treated granulated matter 12 from the outlet 26 at the bottom 28 of the chamber 20. In other embodiments, the apparatus 10 has one or more conveyors 100 for moving granulated matter 12 to the hopper 80 or the inlet 22 of the chamber 20. In embodiments, the conveyor 100 may be considered the granulated matter metering device 88 or may be used in addition to the granulated matter metering device 88 to deliver granulated matter 12 to the such metering device 88. In further embodiments, the conveyor 100 may be connected with the calibration unit 90, so that the speed of the conveyor 100 may be matched to particular rates of the one or more metering device 84, 88.

### Granulated Matter and Additives

In various embodiments, the present invention provides an apparatus for treating certain granulated matter 12, including agricultural products like seeds, with liquid or dry additives 14. Indeed, seed that can be treated with the apparatus 10 include that from soybean, peanut, corn, legume, cereal, grass, cotton, oil, or vegetable plants. Moreover, seed can include that from a combination of sources. Also, it is foreseen that other granulated matter 12 agricultural products might be coated or mixed with an additive 14 through the use of the apparatus 10 herein. For example, certain fertilizers, like pearled urea, might be treated with an additive 14 through the apparatus 10. Treatment herein is understood to mean the agricultural product is coated, impregnated, and/or mixed with the additive 14.

Further, the additives 14 can include any desired and suitable compound. For example, granulated matter 12 might be treated with a pesticide to protect such products or soil it is applied to from pests. Moreover, granulated matter 12 might be treated with microbial compounds to enhance plant growth and resilience or prevent mold. Further, granulated matter 12 might be treated with a cellulose fiber compound to enhance flowability. However, the above examples are not to be considered limiting in any way as a variety of compounds might be considered suitable additives 14 and such compounds are readily known and apparent to those of skill in the art.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive subject matter. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that when an element or layer is referred to as being “on” another element or layer, the element or layer can be directly on another element or layer, or intervening elements or layers may also be present. In contrast, when an element is referred to as being “directly on” another element or layer, there are no intervening elements or layers present. As used herein, the term “and/or” includes any and all combinations of one or more of the associated listed items.

Spatially relative terms, such as “below,” “beneath,” “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. Throughout the specification, like reference numerals in the drawings denote like elements.

Embodiments of the inventive subject matter are described herein with reference to plan and perspective illustrations that are schematic illustrations of idealized embodiments of the inventive subject matter. As such, variations from the shapes of the illustrations as a result, for example, of manufacturing techniques and/or tolerances, are to be expected. Thus, the inventive subject matter should not be construed as limited to the particular shapes of objects illustrated herein, but should include deviations in shapes that result, for example, from manufacturing. Thus, the objects illustrated in the figures are schematic in nature and their shapes are not intended to illustrate the actual shape of a region of a device and are not intended to limit the scope of the inventive subject matter.

The terminology used herein is for the purpose of describing particular embodiments only and is not intended to be limiting of the present inventive subject matter. As used herein, the singular forms “a,” “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present inventive subject matter belongs. It will be further understood that terms used herein should be interpreted as having a meaning that is consistent with their meaning in the context of this specification and the relevant art and will not be interpreted in an idealized or overly formal sense unless expressly so defined herein. The term “plurality” is used herein to refer to two or more of the referenced items. Although any methods, devices, and materials similar or equivalent to those described herein can be used in the practice or testing of the presently disclosed subject matter, representative methods, devices, and materials are now described.

In the drawings and specification, there have been disclosed typical preferred embodiments of the inventive subject matter and, although specific terms are employed, they are used in a generic and descriptive sense only and not for purposes of limitation, the scope of the inventive subject matter being set forth in the following claims.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A gravity-fed treatment apparatus for the dispersion of an additive into a flow of granulated matter, the apparatus comprising:
a vertical treatment chamber comprising
an inlet at a top thereof and an outlet at a bottom thereof,
a first and second U-shaped channel member, wherein each U-shaped channel member has a central segment and arm segments, wherein the arm segments are affixed to and extend away from opposed edges of the respective central segment, and wherein the first and second U-shaped channel members define the periphery of an interior of the chamber between the top and the bottom when an edge of each arm segment of the first U-shaped channel abuts an edge of each arm segment of the second U-shaped channel,
a plurality of vortex baffles disposed away from opposed portions of the periphery into the interior at respective angles, wherein each of the plurality of vortex baffles comprises a flat portion having a first surface and a flaring portion curving up and away from a plane encompassing the first surface, and
a first feed port disposed through at least one of the first and second U-shaped channel members configured to deposit the additive into the flow of granulated matter between the inlet and the outlet;
whereby at least a portion of the flow of granulated matter deposited through the inlet spirals around an axis passing through the top and bottom of the chamber as it is pulled by gravity towards the outlet due to the deflection of the granulated matter by the plurality of vortex baffles to enhance dispersion of the additive relative to the granulated matter.

2. The gravity-fed treatment apparatus of claim 1, further comprising a frustoconical-shaped hopper affixed to the inlet.

3. The gravity-fed treatment apparatus of claim 1, wherein the plurality of vortex baffles are serially disposed from opposed portions of the periphery.

4. The gravity-fed treatment apparatus of claim 1, wherein each of the plurality of vortex baffles are affixed to portions of the periphery such that the respective angle of each of the plurality of vortex baffles is fixed.

5. The gravity-fed treatment apparatus of claim 1, wherein at least one of the plurality of vortex baffles is pivotally affixed to a portion of the periphery such that the respective angle of the at least one of vortex baffles is alterable.

6. The gravity-fed treatment apparatus of claim 5, wherein the at least one pivotally affixed vortex baffle is operably connected to an adjustment bar configured to infinitely adjust the respective angle of the at least one of vortex baffles.

7. The gravity-fed treatment apparatus of claim 6, wherein the adjustment bar is disposed on an opposed side of the periphery from the interior of the chamber.

8. The gravity-fed treatment apparatus of claim 5, wherein the at least one pivotally affixed vortex baffle contacts a protrusion extending from the periphery into the interior of the chamber configured to secure the at least one pivotally affixed vortex baffle such that the respective angle thereof is a set angle.

9. The gravity-fed treatment apparatus of claim 8, wherein the protrusion is disposed at an adjustable location along the periphery and wherein the set angle is related to the adjustable location.

10. The gravity-fed treatment apparatus of claim 1, wherein at least one of the plurality of vortex baffles is removably affixed to the periphery.

11. The gravity-fed treatment apparatus of claim 10, wherein a portion of the at least one of removably affixed vortex baffles is disposed into and in frictional engagement with a slot into a portion of one of the first and second U-shaped channel members.

12. The gravity-fed treatment apparatus of claim 1, wherein the first feed port is in communication with a first metering device configured to control the input rate of additive to the interior of the chamber.

13. The gravity-fed treatment apparatus of claim 12, wherein the additive comprises a fluid, wherein the first metering device comprises a chemical metering pump in fluid communication with the first feed port, and wherein the first feed port comprises a nozzle configured to spray the additive into the interior of the chamber to contact the flow of granulated matter.

14. The gravity-fed treatment apparatus of claim 12, wherein the additive is non-fluid and the first metering device is one of a fluted feed type, internal double run type, cup feed type, cell feed type, brush feed type, auger feed type, picker wheel type, and star wheel type.

15. The gravity-fed treatment apparatus of claim 12, further comprising a second feed port disposed through at least one of the first and second U-shaped channel members and a second metering device in communication with the second feed port, wherein the second metering device is configured to control the input rate of additive to the interior of the chamber.

16. The gravity-fed treatment apparatus of claim 15, wherein the first metering device and second metering device are operably linked through a calibration unit configured to control the input rate of additive to the interior through each of the first feed port and second feed port.

17. The gravity-fed treatment apparatus of claim 1, wherein the flow through the inlet is through a first metering device configured to control the flow rate of granulated matter into the interior of the chamber.

18. The gravity-fed treatment apparatus of claim 17, further comprising a second metering device in communication with the first feed port, wherein the first metering device and second metering device are operably linked through a calibration unit configured to maintain a preset ratio of the additive to granulated material in the flow.

19. A gravity-fed treatment apparatus for the dispersion of an additive into a flow of granulated matter, the apparatus comprising:
a vertical treatment chamber comprising
at least one inlet at a top thereof and an outlet at a bottom thereof,
at least one wall disposed between the top of the chamber and bottom of the chamber,
an interior of the chamber defined between the top, bottom, and at least one wall,
a plurality of vortex baffles disposed away from interior portions of the at least one wall into the interior at respective angles, wherein each of the plurality of vortex baffles comprises a flat portion having a first surface and a flaring portion curving up and away from a plane encompassing the first surface, and
a first feed port disposed through the at least one wall configured to deposit the additive into the flow of granulated matter between the inlet and the outlet;
whereby at least a portion of the flow of granulated matter deposited through the inlet spirals around an axis passing through the top and bottom of the chamber as it is pulled by gravity towards the outlet due to the deflection of the granulated matter by the plurality of vortex baffles to enhance dispersion of the additive relative to the granulated matter.
